(19) United States
(12) Patent Application Publication
(10) Pub. No.: US 2014/0341698 A1
(43) Pub. Date: Nov. 20, 2014

(54) RELOCATION AND SUPPORT DEVICE

(71) Applicants: Anthony FRANCO, North Bellmore, NY (US); Daniel MOONEY, Massapequa, NY (US)

(72) Inventors: Anthony FRANCO, North Bellmore, NY (US); Daniel MOONEY, Massapequa, NY (US)

(21) Appl. No.: 14/251,143

(22) Filed: Apr. 11, 2014

Related U.S. Application Data
(63) Continuation of application No. 13/437,820, filed on Apr. 2, 2012.
(60) Provisional application No. 61/516,195, filed on Mar. 31, 2011.

(51) Int. Cl. F16M 11/24

(52) U.S. Cl. CPC F16M 11/24
USPC 414/800; 248/669

(57) ABSTRACT

The present invention relates to the relocation and support of construction equipment. Specifically, the invention relates a relocation and support device which supports a machine on a working deck by transferring the machine load to the structure through reaction collar assembly units. Additionally, the invention enables the vertically relocation of a machine. Safety features are included.

### RELATED APPLICATION DATA

This application is a continuation of application Ser. No. 13/437,820, filed on Apr. 2, 2012, which claims the benefit of and priority under 35 U.S.C. 119(e) of U.S. Patent Application No. 61/516,195 filed on Mar. 31, 2011. The entire content of both of these applications is incorporated herein by reference, for all purposes.

### FIELD OF THE INVENTION

The present invention is in the technical field of construction equipment. More particularly, the present invention is in the technical field of cranes, derricks, pumps, material hoisting and any type of construction related machinery or equipment.

### BACKGROUND INFORMATION

Structures such as multistory buildings are usually built one level at a time. As each level is completed, the construction equipment needed for building the next level must be relocated to the higher level. Currently, this process involves the permanent erection and placement of construction equipment and devices. There is a need for a device that can vertically relocate pieces of construction equipment quickly and efficiently without installing permanent pieces of construction equipment or devices.

### SUMMARY OF THE INVENTION

The present invention is a device that can be utilized to support a construction machine of any type, size, capacity, design, function, or method of manufacture including but not limited to: cranes, derricks, jibs, hoists, winches, drums concrete pumps or other devices used in construction. The invention can be used to assist in the support, relocation, hoisting, jacking, jumping, raising or any other term used to describe the lifting of the invention vertically to different levels of a building or other structure. A failsafe mechanism is incorporated as a unique safety feature.

The present invention relates to the relocation and support of construction equipment. Specifically, the invention relates a relocation and support device which supports a machine on a working deck by transferring the machine load to the structure through reaction collar assembly units. Additionally, the invention enables the vertical relocation of a machine.

In one embodiment, the present invention provide for a relocation and support device for a machine. In one example, the relocation and support device is attached to a machine. The relocation and support device includes a mounting flange; at least one relocation sheave; a reaction collar assembly; a reaction pipe; a bearing pin; a relocation cable; and a cable dead end. In one aspect, the relocation and support device optionally includes a relocation hoist, a second upper relocation sheave and/or a power unit.

In one aspect, the reaction collar assembly of the relocation and support device includes: a reaction collar plate, a thrust angle, a stiffener plate, a bearing beam assembly, a lifting beam, a lifting beam pin, a failsafe assembly, a wedge block, a spacer block, a shim plate, a failsafe stop roller, a failsafe adjustment bolt and a failsafe seating bolt.

In another aspect, the failsafe system of the relocation and support device includes: a failsafe assembly, a wedge block, a spacer block, a shim plate, a failsafe stop roller, a failsafe adjustment bolt and a failsafe seating bolt. In a further aspect, the wedge block of the failsafe system has an angle such that it prevents downward movement of the reaction pipe and machine. In a preferred aspect, the wedge block has a 7-10 degree angle.

In yet another aspect, the reaction collar assembly of the relocation and support device can be successively relocated to follow the machine each time the machine is vertically relocated.

In another embodiment, the invention provides for a method of relocating a machine. The method includes: secure a lifting or relocation cable to a bearing beam pipe which is attached to a lifting beam; a power source rotates a relocation hoist, a sheave or series of sheaves; and a relocation cable winds over a relocation sheave onto or over the relocation hoist, sheave or sheaves; wherein the machine is lifted to a higher vertical position.

In a further embodiment, the present invention provides for the use of a relocation and support device to relocate a machine.

In one embodiment, the present invention provides for the use of a relocation and support device to support a machine by transferring the machine load and the loads imposed by the machine.

### BRIEF DESCRIPTION OF THE DRAWINGS

FIG. 1 is a drawing of the relocation and support device on the relocation reaction floor of a structure.

FIG. 2 is a drawing of the reaction collar assembly.

FIG. 3 is a drawing of the reaction collar assembly showing the placement of the bearing pin.

FIG. 4 is a drawing of the failsafe system.

### DETAILED DESCRIPTION OF THE INVENTION

The present invention relates to the relocation and support of construction equipment. Specifically, the invention relates to a relocation and support device which supports a machine on a relocation reaction floor, or highest floor yet to be constructed, by transferring the machine load to the structure through one or more reaction collar assembly units. Additionally, the invention enables the vertical relocation of a machine.

Before the present compositions and methods are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

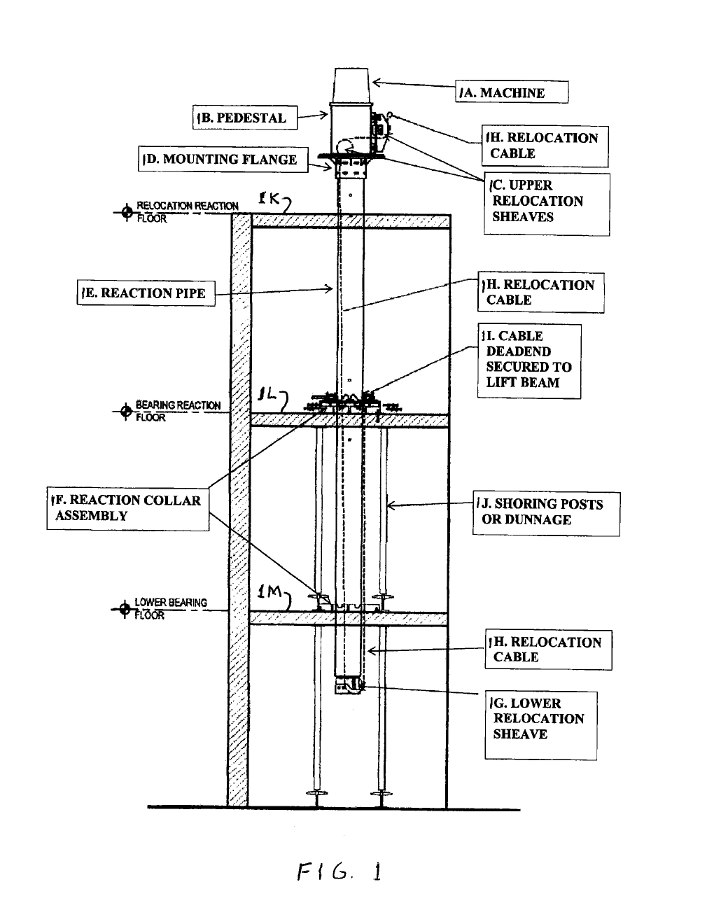

Referring to FIG. 1, the term “relocation and support device” refers to any device which can provide support for a machine 1A by transferring the load of the machine 1A to a structure and which can also vertically relocate a machine 1A. FIG. 1 includes the following: machine 1A; the pedestal of the machine 1B; upper relocation sheave(s) 1C; mounting flange 1D; reaction pipe 1E; reaction collar assembly 1F; lower relocation sheave 1G; relocation cable 1H; cable dead end 1I; shoring posts or dunnage 1J.

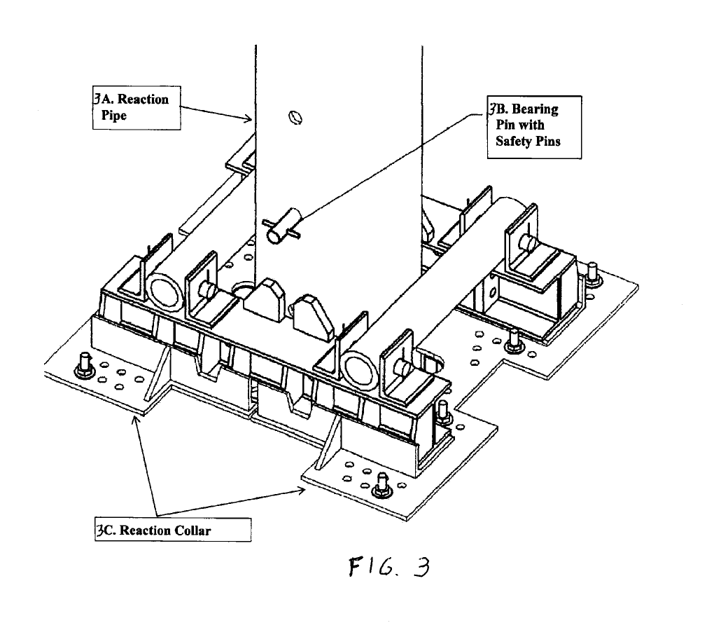

In one embodiment a relocation and support device includes the following components: a mounting flange 1D, at least one relocation sheave 1C and 1G, a reaction pipe 1E, a bearing pin 3B (FIG. 3), a relocation cable 1H, a cable dead end 1I, and a reaction collar assembly 1F. The relocation and support device may optionally include a relocation hoist and/or a power unit. The relocation and support device is located on a relocation reaction floor 1K or the highest floor yet to be constructed.

As used herein the term “machine” refers to any piece of construction equipment which needs to be supported or vertically relocated. Examples of a machine include but are not limited to cranes, derricks, jibs, hoists, winches, drums, concrete pumps or other devices used in construction. In one aspect the relocation and support device is attached to a machine 1A at the mounting flange 1D using bolts. The machine 1A could be, but is not required to be, mounted in various ways and using various methods to a vertical pedestal 1B of various sizes, shapes, dimensions and materials including but not limited to metal, wood, plastics, composites or any other material and methods of manufacture. In another aspect the relocation and support device is attached to the machine 1A at the pedestal 1B.

The term “relocation reaction floor” refers to the level of a structure on which the machine is currently located.

The mounting flange 1D attaches the machine 1A to the relocation and the support device. The machine is connected to the mounting flange 1D by the means specified by the manufacturer of the machine, by welding, bolting or any structurally acceptable method, but most often by using bolts. The mounting flange 1D can be of any suitable size. In one example, the mounting flange 1D is 2 foot-8 foot and of any shape. In a preferred example, the mounting flange 1D is a 2 foot by 2 foot square. The mounting flange 1D has a hole manufactured into it which allows the relocation cable 1H to pass through and facilitates the attaching of the reaction pipe 1E. The hole can be 6 inches to 48 inches in diameter. In a preferred example, the hole is 16 inches in diameter. The mounting flange 1D can be made of any material. In one example mounting flange 1D can be made of metal, wood, plastics, composites or any other material and methods of manufacture. In a preferred example, the mounting flange 1D is made of steel.

The relocation and support device of the invention has at least one upper relocation sheave 1C and one lower relocation sheave 1G, but may have more.

The first, upper relocation sheave 1C is attached to the mounting flange 1D or the pedestal 1B. A sheave is a wheel or roller with a groove along its edge for holding a belt, rope or cable. When hung between two supports and equipped with a belt, rope or cable, one or more sheaves make up a pulley. The words sheave and pulley are sometimes used interchangeably. A sheave can also refer to a pulley which has an adjustable operating diameter for use with a belt. This is accomplished by constructing the pulley out of several pieces. The two main “halves” of the pulley can be moved closer together or farther apart, thus altering the operational diameter. The usual construction is some sort of locking collar or set screws to secure the components, one half with a threaded central shaft and one half with a threaded center.

The first, upper relocation sheave 1C acts as a guide for the relocation cable 1H to a hoist or to a second upper relocation sheave that could facilitate attaching the relocation cable to the hoist or hoist cable of the machine 1A. The hoist may be a relocation hoist attached to the mounting flange 1D, may be part of machine 1A or a separate stand-alone unit. The first upper relocation sheave 1C can be of any shape. In one example, the first upper relocation sheave 1C is round. The first upper relocation sheave 1C can be made of any material. In one example the first upper relocation sheave 1C is made of metal, wood, plastics, composites or any other material and methods of manufacture. In a preferred aspect, the first upper relocation sheave 1C is made of steel. The first upper relocation sheave 1C can be of any size. In one example, the first upper relocation sheave 1C is 6 to 20 inches in diameter. In a preferred aspect first, upper relocation sheave 1C is 10 inches in diameter. The first upper relocation sheave 1C can be attached to the mounting flange 1D inside the pedestal or attached directly to the pedestal by welding, bolting or any structurally acceptable method. The first upper relocation sheave 1C can be a sheave, pulley or roller, or one or more sheaves, pulleys or rollers with or without a manual or power operated hoist.

The first, upper relocation sheave 1C is attached inline to a second upper relocation sheave or a hoist which is either a relocation hoist attached to the mounting flange 1D, a hoist attached to the machine, or the hoist could be a separate stand-alone unit. A hoist is a device used for lifting or lowering a load by means of a drum or lift-wheel around which rope or chain wraps. It may be manually operated, electrically or pneumatically driven and may use chain, fiber or wire rope as its lifting medium. The hoist acts to vertically relocate the machine 1A by wrapping the relocation cable 1H around a roller. The hoist or second upper relocation sheave 1C is attached to the pedestal 1B and/or mounting flange 1D. The hoist may be a manual or power operated hoist, winch or other lifting device. The hoist or relocation hoist or the second upper relocation sheave 1C may be of any size. In one example, the hoist or second upper relocation sheave 1C is 6 inches to 36 inches in diameter. In a preferred example, the hoist or second upper relocation sheave 1C is 10 inches in diameter. The hoist or second upper relocation sheave 1C may be made of any material. In one example the hoist or second upper relocation sheave 1C is made from metal, wood, plastics, composites or any other material and methods of manufacture. In a preferred, example the hoist or second upper relocation sheave 1C is made of steel.

A lower relocation sheave 1G is located at the end or bottom of the reaction pipe 1E. The lower relocation sheave 1G can be made of any material. In one example, the lower relocation sheave 1G is made of metal, wood, plastics, composites or any other material and methods of manufacture. In a preferred example, lower relocation sheave 1G is made of steel. The lower relocation sheave 1G can be of any size. In one example, the lower relocation sheave 1G is 6 inches to 36 inches in diameter. In a preferred example, the lower relocation sheave 1G is 12 inches in diameter. The lower relocation sheave 1G is attached to the reaction pipe 1E by welding, bolting or any structurally acceptable method. Additional relocation sheaves may be used as necessary.

A power unit can be attached to the machine or stand separately. The source of power generation can be attached the machine by the method required by the chosen power unit. This could be hydraulic hoses, electrical wires, fiber optic cables or any other method or source. The power unit acts to provide power to the machine and hoist. The power unit can be of manual, diesel, gasoline, propane, electric, fluid, solar or any other power source yet to be discovered.

The mounting flange 1D, first upper relocation sheave 1C, power unit and optionally a relocation hoist or second upper relocation sheave 1C may be separate components or encased as a single unit.

The mounting flange 1D, first upper relocation sheave 1C and optionally a relocation hoist or second upper relocation sheave 1C is then attached collectively or separately to at least one reaction pipe 1E or similar vertical support. The reaction pipe 1E extends through a hole or shaft just slightly larger than the chosen size of the reaction pipe at least two floors below the mounting flange 1D and relocation reaction floor 1K or the highest floor yet to be constructed through the support dunnage. The support dunnage is optional and its use is determined by the structural design of the structure upon which the relocation and support device is mounted. Its purpose would be to add support if necessary.

The reaction pipe 1E houses the relocation cable 1H. The reaction pipe 1E is attached to the mounting flange 1D by welding, bolting or any structurally acceptable method. The reaction pipe 1E must be hollow, houses a relocation cable 1H and has a lower relocation sheave 1G attached to the lowest point of the reaction pipe. The reaction pipe 1E can be of any size. In one example, the reaction pipe 1E is 6 inches by 48 inches in diameter. In a preferred example, the reaction pipe 1E is 16 inches in diameter and ¼ inch in thick. The reaction pipe 1E can be made of any material. In one example, the reaction pipe 1E is made of metal, wood, plastics, composites or any other material and methods of manufacture. In a preferred example, the reaction pipe 1E is made of steel.

The reaction collar assembly 1F is attached to each bearing floor below the relocation reaction floor 1K or the highest floor yet to be constructed through which the reaction pipe 1E passes. The reaction collar assembly 1F rests on or is secured to the building structure, in various methods, thus transferring the imposed loads from the machine 1A to the building structure. Unlike other devices, the reaction collar assembly 1F is manufactured with cutouts or in such a way that allows the use of support dunnage or posts in the original structure to fit inside or around the reaction collar assembly 1F and since it is not attached to the post in the structure the reaction collar assembly 1F is movable and is not permanently attached to the structure. In one embodiment of the invention, the reaction collar assembly 1F is relocated and reused at a higher level in the structure as the machine 1A is vertically relocated as is the reaction collar assembly 1F in accordance with the invention. A separate reaction collar, assembly or similar device or components may or may not be secured to several locations or floors as required. The floor or deck that has a reaction collar assembly 1F with a cable dead end 1I is referred to as a bearing reaction floor 1L. The floor or deck that has a reaction collar assembly without a cable dead end is referred to as a lower reaction floor or lower bearing floor 1M.

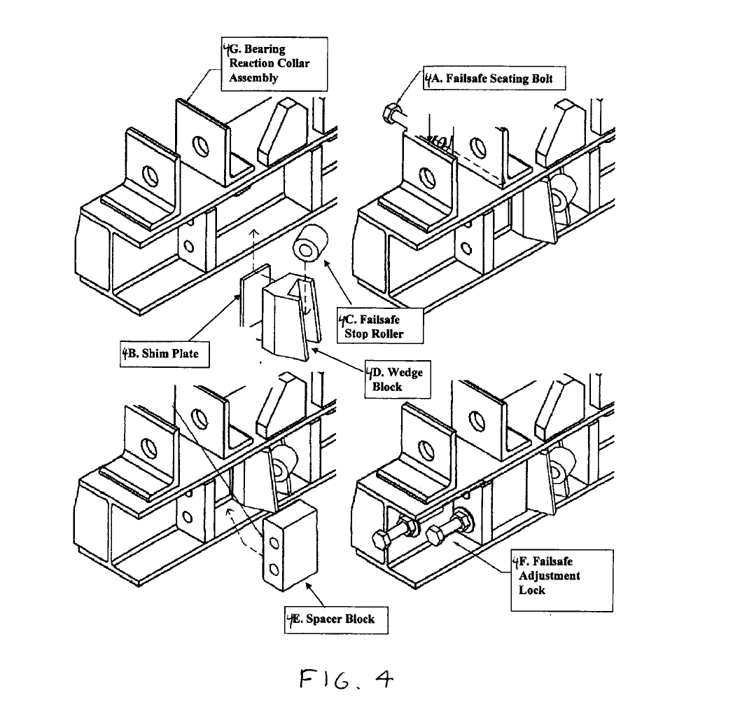

FIG. 4, includes a failsafe seating bolt 4A; shim plate 4B; failsafe stop roller 4C; wedge block 4D; spacer block 4E; failsafe adjustment lock 4F; and bearing reaction collar assembly 4G. Unlike other devices, the reaction collar assembly 1F utilizes a unique fail safe system to prevent the machine 1A from falling if the relocation cable 1H malfunctions. The failsafe system has the following components: a failsafe assembly or locks, a wedge block 4D, a spacer block 4E, shim plates 4B, a failsafe stop roller 4C, failsafe adjustment bolts 4F, and a failsafe seating bolt 4A. The failsafe system has several unique functions such as an additional stabilizing attachment to the reaction collar assembly and as a positive mechanical gravity applied locking device such that the wedge block 4D is on an angle which as the reaction pipe ascends vertically, the failsafe roller 4C is pushed up away from the reaction pipe 1E during the relocation operation. If the reaction pipe 1E started to descend for any reason the weight of the invention and the attached machine would cause the failsafe roller 4C to move down the angle of the wedge block 4D and thus causes the fail safe roller to wedge against the reaction pipe 1E and stop the descent of the reaction pipe, the invention and the attached machine 1A. One reaction collar assembly 1F generally requires at least four failsafe assemblies and only one reaction collar assembly is required to have the failsafe assembly. But they can be installed on multiple reaction collar assemblies for an extra safety factor.

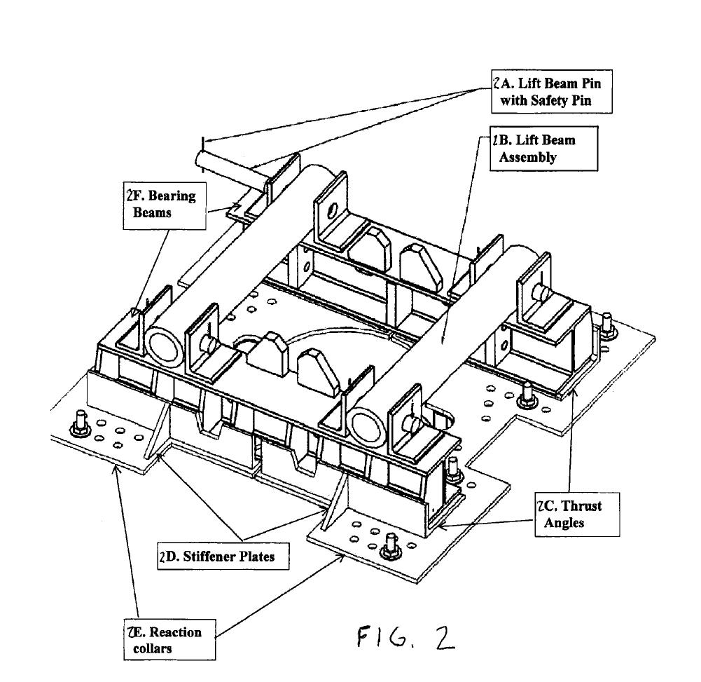

Referring to FIG. 2, the reaction collar assembly has at least one of the following components: a reaction collar plate, a thrust angle or angles 2C, stiffener plates 2D, a bearing beam or bearing beam assembly 2F, a lift beam assembly 2B with safety pin, a lifting beam pipe, a lifting beam pin 2A, a failsafe assembly or locks, and in FIG. 4, a wedge block 4D, a spacer block 4E, shim plates 4B, a failsafe stop roller 4C, failsafe adjustment bolts 4F and a failsafe seating bolt 4A.

The reaction collar plate 2E is attached to each bearing floor below the relocation reaction floor 1K or the highest floor yet to be constructed that the reaction pipe 1E passes through and is designed with specific cut outs to accommodate post(s) or support dunnage 1J thus lining the support dunnage of the structure. Reaction collar plate 2E can be of various shapes and sizes. In one example, reaction collar plate 2E is 6 inches to 72 in length and width in any shape. In a preferred example, the reaction collar plate 2E is 30 inches square with a circular cut out in the center large enough for the reaction pipe 1E to pass through. The reaction collar plate 2E can be made from any material. In one example, the reaction collar plate 2E is made of metal, wood, plastics, composites or any other material and methods of manufacture. In a preferred example, reaction collar plate 2E is made of steel. The reaction collar plate may be in one or more pieces to fit around the support dunnage or posts.

The thrust angle 2C is attached to the reaction plate or collar by welding, bolting or any structurally acceptable method. The thrust angle 2C serves to add support and strength to the bearing beams 2F and the reaction collar assemblies 1F. The thrust angle 2C may or may not be required based on the size of the entire relocation and support device or machine attached. The thrust angle 2C can be of various shapes and sizes. In one example, the thrust angle 2C is 2 inches to 12 inches in length, width and height depending on the size of the bearing beam. In a preferred example, the thrust angle 2C is 3 feet in length, 4 inches in height and 7 inches in width. The thrust angle 2C can be made from any material. In one example, the thrust angle 2C is made of metal, wood, plastics, composites or any other material and methods of manufacture. In a preferred example, the thrust angle 2C is made of steel.

The stiffener plates 2D are attached to the bearing beams 2F by welding, bolting or any structurally acceptable method. The stiffener plates 2D serves to add strength and support to the bearing beams 2F. The stiffener plates 2D may or may not be required based on the size of the entire embodiment or the machine attached to the embodiment. There is at least one of the stiffener plate 2D per reaction collar assembly 1F. The stiffener plates 2D can be of various shapes and sizes. In one example, the stiffener plates 2D are 0.5 inch to 10 inches in length, width and thickness depending on the size of the bearing beam. In a preferred example, the stiffener plates 2D is 6 inches in height, 3 inches wide and 1 inch thick. The stiffener plates 2D can be made from any material. In one example, the stiffener plates 2D are made of metal, wood, plastics, composites or any other material and methods of manufacture. In a preferred example, the stiffener plates 2D are made of steel.

The bearing beam assembly 2F serves to support the bearing pin 3B (FIG. 3) and the failsafe assemblies. The bearing beam assembly 2F is attached to the reaction plate or collar by welding, bolting or any structurally acceptable method. The bearing beam 2F assembly can be of various shapes and sizes. In one example, the bearing beam 2F assembly is 2 inches to 24 inches in length, width and height. In a preferred example, the bearing beam 2F assembly is 3 feet in length, 6 inches in height and 6 inches in width. The bearing beam 2F assembly can be made from any material. In one example, the bearing beam 2F assembly is made of metal, wood, plastics, composites or any other material and methods of manufacture. In a preferred example, the bearing beam 2F assembly is made of steel.

The lift beam assembly (FIG. 2) serves to add strength and support to the bearing beams 2F and reaction collar assemblies and to attach the deadend of the relocation cable 1I. The lifting beam is attached to the bearing beams 2F or reaction collar assemblies by removable pins or by welding, bolting or any structurally acceptable method. The lifting beam can be of various shapes and sizes. In one example, the lifting beam is 0.5 inches to 36 inches in length, diameter and thickness. In a preferred example, the lifting beam is 28 inches in length, 4.5 inches in diameter and 0.5 inches thick. The lifting beam can be made from any material. In one example, the lifting beam is made of metal, wood, plastics, composites or any other material and methods of manufacture. In a preferred example, the lifting beam is made of steel.

The lifting beam pin 2A serves to attach the lifting beam to the bearing beam 2F in a easily installed and removable method. The lifting beam pin 2A is attached to the lifting beam and the bearing beam 2F by bolts or removable lock pins or cotter pins. The lifting beam pin 2A can be of various shapes and sizes. In one example, the lifting beam pin 2A is 0.5 inch to 10 inches in length and diameter. In a preferred example, the lifting beam pin 2A is 8.5 inches in length and 1.5 inches in diameter. The lifting beam pin 2A can be made from any material. In one example, the lifting beam pin 2A is made of metal, wood, plastics, composites or any other material and methods of manufacture. In a preferred example, the lifting beam pin is made of steel.

The failsafe assembly or locks serve several unique functions such as an additional stabilizing attachment to the reaction collar assembly and as a positive mechanical gravity applied locking device such that the wedge block 4D is on an angle which as the reaction pipe ascends vertically, the failsafe roller is pushed up away from the reaction pipe 1E during the relocation operation. If the reaction pipe 1E started to descend for any reason the weight of the relocation device and the attached machine 1A would cause the failsafe roller to moves down the angle of the wedge block 4D and thus causes the failsafe roller 4C to wedge against the reaction pipe 1E and stop the descent of the reaction pipe, the relocation device and the attached machine 1A. The failsafe assembly or locks is attached to the bearing beam 2F or reaction collar assembly by welding, bolting or any structurally acceptable method.

The wedge block 4D serves to support the failsafe roller and to activate the locking feature of the invention. The wedge block 4D is attached to the bearing beam 2F by welding, bolting or any structurally acceptable method. The wedge block 4D can be of various shapes and sizes. In one example, the wedge block 4D has an angle of 1 to 10 degrees. The wedge block 4D can be made from any material. In a preferred example, the wedge block has an angle of 7 to 10 degrees. In one example, the wedge block 4D is made of metal, wood, plastics, composites or any other material and methods of manufacture. In a preferred example, the wedge block 4D is made of steel.

The spacer block 4E serves to adjust the wedge block 4D and failsafe roller 4C into contact with the reaction pipe 1E and provides structural support to the failsafe assembly. The spacer block 4E is attached to the bearing beam 2F and the wedge block 4D by adjustment bolts, pins or similar device or method. The spacer block 4E can be of various shapes and sizes. In one example, spacer block 4E is 1 inch to 10 in thickness, width and height. In a preferred example, the spacer block 4E is 3.5 inches wide, 5 inches in height and 2 inches thick. The spacer block 4E can be made from any material. In one example, the spacer block 4E is made of metal, wood, plastics, composites or any other material and methods of manufacture. In a preferred example, the spacer block 4E is made of steel.

The shim plates 4B serve to assist in the adjustment of the wedge block 4D and failsafe assemblies to properly contact the reaction pipe 1E. The shim plates 4B can be attached to the bearing beams 2F or the wedge block 4D by welding, bolting or any structurally acceptable method. The shim plates 4B can be of various shapes and sizes. In one example, shim plate 4B is 1 inch to 12 inches in height and width. In a preferred example, the shim plates 4B are 4.5 inches in height and 2.5 inches in width. The shim plates 4B can be made from any material. In one example, the shim plates 4B are made of metal, wood, plastics, composites or any other material and methods of manufacture. In a preferred example, the shim plates 4B are made of steel.

The failsafe stop roller 4C serves to create a positive and moveable or adjustable method of contact between the reaction pipe 1E and the wedge block 4D thereby allowing the invention to ascend while still providing a positive method to prevent the invention from descending or falling. The failsafe stop roller 4C is attached to the reaction pipe 1E and the wedge block 4D by gravity and physical contact. The failsafe stop roller 4C can be of various shapes and sizes. In one example, the failsafe stop roller 4C is 1 inch to 12 inches in diameter and thickness. In a preferred example, the failsafe stop roller 4C is 2.5 inches in diameter and 1 inch thick. The failsafe stop roller 4C can be made from any material. In one example, the failsafe stop roller 4C is made of metal, wood, plastics, composites or any other material and methods of manufacture. In a preferred example, the failsafe stop roller 4C is made of steel.

The failsafe adjustment bolts 4F serve to assist in the adjustment of the spacer blocks 4E, wedge blocks 4D and failsafe assemblies and rollers 4C to properly contact the reaction pipe 1E. The failsafe adjustment bolts 4F are attached to the bearing beam 2F and the spacer blocks 4E through threads, adjustment holes or similarly adjustable method. The failsafe adjustment bolts 4F can be of various shapes and sizes. In one example, the failsafe adjustment bolts 4F are 0.25 inches to 3 inches in diameter and length. In a preferred example, the failsafe adjustment bolts 4F are 1 inch in diameter and 4.5 inches in length. The failsafe adjustment bolts 4F can be made from any material. In one example, the failsafe adjustment bolts 4F are made of metal, wood, plastics, composites or any other material and methods of manufacture. In a preferred example, the failsafe adjustment bolts 4F are made of steel.

The failsafe seating bolt 4A serves to positively lock the wedge block 4D and failsafe assembly into the proper position after they are adjusted to properly contact the reaction pipe 1E. The failsafe seating bolt 4A is attached to the bearing beam 2F and the wedge block 4D through threaded holes in both the bearing beam 2F and the wedge block 4D. The failsafe seating bolt 4A can be of various shapes and sizes. In one example, the failsafe seating bolt 4A is 0.25 inches to 6 inches in diameter and length. In a preferred example, the failsafe seating bolt 4A is 0.75 inches in diameter and 1.75 inches in length. The failsafe seating bolt 4A can be made from any material. In one example, the failsafe seating bolt 4A is made of metal, wood, plastics, composites or any other material and methods of manufacture. In a preferred example, the failsafe seating bolt 4A is made of steel.

Referring to FIG. 3, a bearing pin 3B may pass through the reaction pipe 1E and rest on the center reaction collar assembly with bearing beams 2F installed; this is called the bearing reaction collar. The bearing reaction collar assembly IF is the reaction collar assembly IF located on the highest level of the structure below the working deck or the highest floor yet to be constructed that the reaction pipe passes through. The bearing pin 3B (with safety pin) serves to hold the reaction pipe 1E in place and it is attached to the bearing reaction collar assembly 1F, which is secured to a floor or structure of sufficient strength and in a manner sufficient to transfer the load of the machine 1A to the structure. The bearing pin 3B may be of various sizes and made from various materials. In one example, the bearing pin 3B is 0.5 inch to 6 inches in diameter and 6 inches to 36 inches in length. In a preferred example the bearing pin 3B is 1⅜ inches in diameter and 24 inches in length. In one example, the bearing pin 3B is made of metal, wood, plastics, composites or any other material. In a preferred example, the bearing pin 3B is made of steel.

The relocation cable 1H is connected from a reaction collar assembly 1F through one or more sheaves to a hoist. In one embodiment, the relocation cable 1H is attached to the upper most reaction collar assembly or what is commonly called the relocation collar assembly and is generally located at the highest floor that can structurally support the loads imposed by the invention and the attached machine. The relocation cable 1H runs down the length of the reaction pipe 1E, around the lower relocation sheave or sheaves 1G located at the bottom of the reaction pipe 1E, up the length of the reaction pipe 1E, inside the reaction pipe 1E, around a first upper relocation sheave 1C and either to the optional relocation hoist or around a second upper relocation sheave 1C and connects to either the cable on the hoist of the machine in an industry acceptable method or directly to the hoist of the machine.

The relocation cable 1H can be of various lengths and thicknesses. In one example, the relocation cable 1H is 20 feet to 100 feet in length and 0.25 inches to 6 inches thick. The relocation cable 1H can be made of various materials. In one example, the relocation cable 1H is made of metal, wood, plastics, rope, composites or any other material formed into a cable. In a preferred example, the relocation cable 1H is ⅝ inches by 50 feet in length.

The cable dead end 1I is located on to the uppermost reaction collar assembly 1F or what is commonly called the relocation collar assembly and is generally located at the highest floor that can structurally support the loads imposed by the invention and the attached machine. The cable dead end 1I functions to secure one end of the relocation cable 1H to the reaction collar assembly 1F. The relocation cable 1H is attached to the cable dead end 1I through shackles, cables, bolts, clamps or other industry accepted methods. The cable dead end 1I could be of various sizes and shapes. In one example, the cable dead end 1I is a hollow or solid cylinder. In another example, the cable dead end 1I is a plate. In a preferred example, the cable dead end 1I is a hollow cylinder 24 inches long and 4.5 inches in diameter. The cable dead end 1I can be made of various materials. In one example, the cable dead end 1I is made of metal, wood, plastics, composites or any other material. In a preferred example, the cable dead end 1I is made of steel.

The relocation and support device of the invention provides support for the machine 1A by transferring the machine 1A loads to the structure. The relocation and support device of the invention vertically relocates the machine 1A. To vertically relocate the machine 1A to a higher level the hoist winds the relocation cable 1H around itself, drawing the lower relocation sheave 1G and the reaction pipe 1E upwards thereby lifting the machine 1A to a higher vertical level. The reaction collar assembly 1F is portable and can be relocated each time the machine 1A is vertically relocated thereby reducing the number of reaction collar assembly 1F units needed.

In an embodiment of the invention, the failsafe system allows the machine 1A to travel in an upward or vertical direction but would “wedge” against the reaction pipe 1E if a downward movement was attempted whether intentionally or unintentionally thereby preventing the machine 1A from lowering or falling unexpectedly due to mechanical failure or human error and providing a mechanical failsafe mechanism if any of the relocation system parts should fail.

What is claimed is:

1. A relocation and support device comprising: a) a mounting flange; b) at least 1 relocation sheave; c) a reaction collar assembly; d) a reaction pipe; e) a bearing pin; f) a relocation cable; and g) a cable dead end.

2. The relocating and support device of claim 1, where in the device optionally comprises a relocation hoist or second upper relocation sheave.

3. The relocation and support device of claim 1, wherein the reaction assembly collar comprises: a reaction collar plate, a thrust angle, a stiffener plate, a bearing beam assembly, a lifting beam, a lifting beam pin, a failsafe assembly, a wedge block, a spacer block, a shim plate, a failsafe stop roller, a failsafe adjustment bolt and a failsafe seating bolt.

4. The relocation and support device of claim 1, wherein the device has a failsafe system comprised of a failsafe assembly, a wedge block, a spacer block, a shim plate, a failsafe stop roller, a failsafe adjustment bolt and a failsafe seating bolt.

5. The relocation and support device of claim 4, wherein the wedge block is at an angle such that it prevents downward movement.

6. The relocation and support device of claim 1, wherein the reaction collar assembly can be relocated as the machine is vertically relocated.

7. The stabilizing device of claim 1, wherein the reaction collar assembly components are selected from the group consisting of: a reaction collar plate, a thrust angle, a stiffener plate, a bearing beam assembly, a lifting beam, a lifting beam pin, a failsafe assembly, a wedge block, a spacer block, a shim plate, a failsafe stop roller, a failsafe adjustment bolt and a failsafe seating bolt.

8. The relocation and support device of claim 1, wherein the device is attached to a machine that that includes a hoist.

9. A relocation and support device comprising:
a) a reaction pipe;
b) a mounting flange for a machine coupled to the reaction pipe;
c) at least one lower relocation sheave;
d) a reaction collar assembly for transferring load from the reaction pipe to a reaction floor;
e) a relocation cable; and
f) a cable dead end; wherein
the relocation cable runs down the length of the reaction pipe, around the at least one lower relocation sheave located proximate a bottom of the reaction pipe, up the length of the reaction pipe inside the reaction pipe, around a first upper relocation sheave and either to a relocation hoist or around a second upper relocation sheave and connects to either the cable on the hoist, or directly to the hoist of the machine.

10. A relocation and support device of claim 9, wherein the cable dead end secures one end of the relocation cable to the reaction collar assembly.

11. The relocating and support device of claim 9, further comprising a relocation hoist.

12. The relocating and support device of claim 9, further comprising a second upper relocation sheave.

13. The relocation and support device of claim 9, wherein the reaction assembly collar comprises: a reaction collar plate, a thrust angle, a stiffener plate, a bearing beam assembly, a lifting beam, a lifting beam pin, a failsafe assembly, a wedge block, a spacer block, a shim plate, a failsafe stop roller, a failsafe adjustment bolt and a failsafe seating bolt.

14. The relocation and support device of claim 9, wherein the device has a failsafe system comprised of a failsafe assembly, a wedge block, a spacer block, a shim plate, a failsafe stop roller, a failsafe adjustment bolt and a failsafe seating bolt.

15. The relocation and support device of claim 14, wherein the wedge block is at an angle such that it prevents downward movement.

16. The relocation and support device of claim 9, wherein the reaction collar assembly can be relocated as the machine is vertically relocated.

17. The relocation and support device of claim 9, wherein the reaction collar assembly components are selected from the group consisting of: a reaction collar plate, a thrust angle, a stiffener plate, a bearing beam assembly, a lifting beam, a lifting beam pin, a failsafe assembly, a wedge block, a spacer block, a shim plate, a failsafe stop roller, a failsafe adjustment bolt and a failsafe seating bolt.

18. A method of relocating a machine, comprising:
a) securing a lifting or relocation cable to a lifting beam pipe which is attached to a bearing beam;
b) using a power source to rotate a relocation hoist, a sheave or series of hoists; and
c) winding a relocation cable over a relocation sheave onto or over the relocation hoist, sheave or sheaves; to lift the machine to a higher vertical position.
